(19) United States
(12) Patent Application Publication
(10) Pub. No.: US 2010/0059479 A1
(43) Pub. Date: Mar. 11, 2010

(54) Power Switch, Especially High Current Switch

(75) Inventors: Ralf-Peter Kurth, Berlin (DE); Wolfgang Kurth, Schorfheide (DE); Ralf-Peter Kurth, Berlin (DE); Michael Kleineberg, Berlin (DE); Clemens Rüthnick, Kleinmachnow (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/300,130

(22) PCT Filed: May 9, 2007
(86) PCT No.: PCT/EP07/54494

§ 371 Date: Nov. 10, 2008

(30) Foreign Application Priority Data
May 10, 2006 (DE) 20 2006 007 973.4

(51) Int. Cl. H01H 33/66

(52) U.S. Cl. 218/118

(57) ABSTRACT

A power switch, especially a high-current switch, has at least one pole unit with a pole head and a pole base and a vacuum switching tube interposed therebetween. The vacuum switching tube has a stationary contact and a movable contact. The stationary contact is connected to a first conductor rail of the pole unit via a first connecting element. The moving contact is connected to a second conductor rail of the pole unit via a second connecting element. The power switch has a higher current carrying capacity because the first connecting element is welded to the first conductor rail and the stationary contact and the second connecting element is welded to the second conductor rail and the moving contact.

The invention relates to a power switch, especially a high-current switch, comprising at least one pole unit with a pole head and a pole base and a vacuum switching tube interposed therebetween, said vacuum switching tube having a fixed contact and a moving contact, the fixed contact being connected to a first conductor rail of the pole unit via a first connecting element and the moving contact being connected to a second conductor rail of the pole unit via a second connecting element.

A power switch of this kind is disclosed in the Siemens publication “Siemens HG 11.11, 1999” for example. The high-current switch disclosed there in the form of a power switch comprises three pole units each having a pole head and a pole base as well as a vacuum switching tube arranged between them in each case. A fixed contact and a moving contact of the vacuum switching tube are connected to first and second conductor rails of the pole unit. With this previously known power switch, connecting elements are screwed to the respective contact on the one hand and to the respective conductor rail on the other for connecting the contacts to the conductor rails.

The object of the present invention is to further develop a power switch of the kind mentioned in the introduction, which has a higher current carrying capacity.

According to the invention, this object is achieved with a power switch of the kind mentioned in the introduction in that the first connecting element is welded to the first conductor rail and the fixed contact, and the second connecting element is welded to the second conductor rail and the moving contact.

Advantageously, force-activated and fused connecting areas are formed by the welds between the first connecting element and the first conductor rail and the fixed contact, and between the second connecting element and the second conductor rail and the moving contact. As a result of these force-activated and fused connecting areas, the current path from the first conductor rail via the vacuum switching tube to the second conductor rail has adequate mechanical stability and does not require screw fittings in the area of the connecting elements. This is advantageous, as the temperature at the screw fittings must not be more than 65 to 75 degrees Kelvin above the ambient temperature of the power switch. Welding dispenses with this problem, as a result of which the current carrying capacity of the whole power switch is considerably increased.

In a preferred embodiment, the second conductor rail has a flexible current conductor and is welded to the flexible current conductor and the second connecting element.

In a particularly preferred embodiment, the connecting elements are electron beam welded. Electron beam welds are particularly advantageous, as the welding seams can be executed with high precision.

The invention is explained in more detail below based on the drawing and an exemplary embodiment with reference to the attached figures. In the drawing:

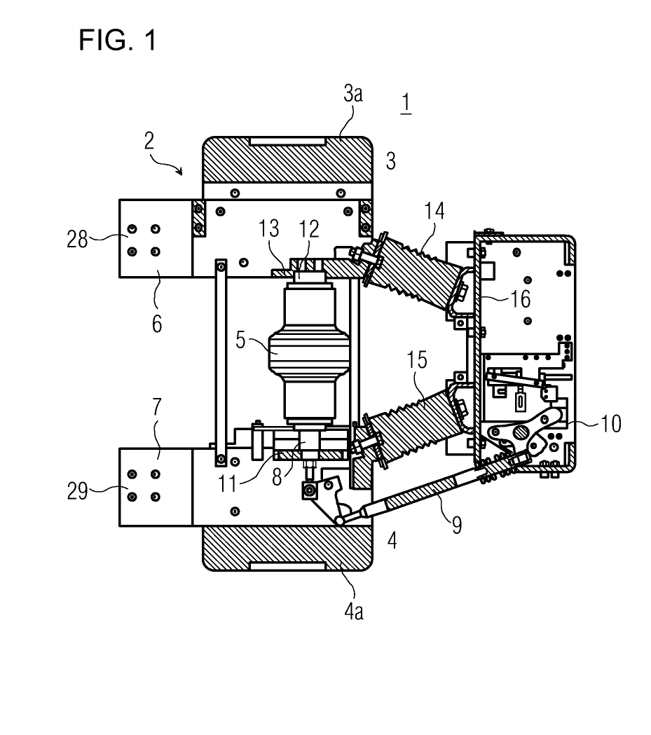

FIG. 1 shows a cross-sectional view of a power switch according to the invention;

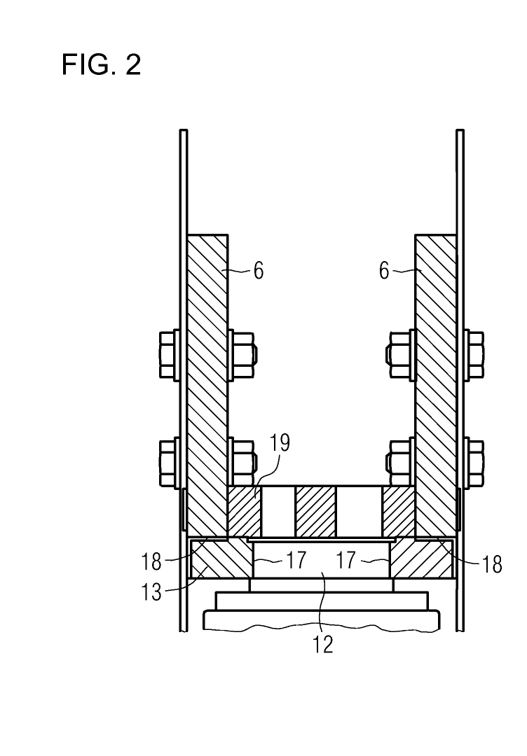

FIG. 2 shows a detailed view in the area of the fixed contact; and

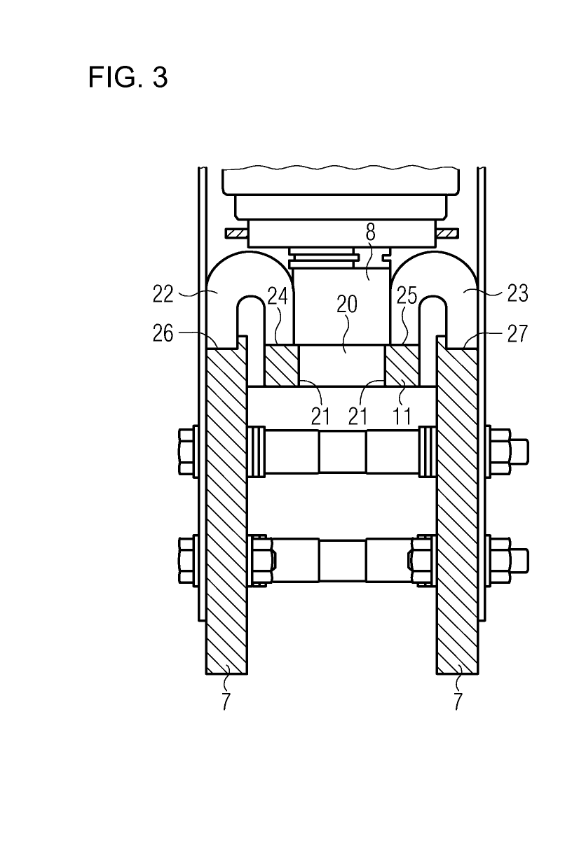

FIG. 3 shows a detailed view in the area of the moving contact.

FIG. 1 shows a high-current switch in the form of a power switch for high-current applications in a cross-sectional view. The power switch 1 comprises three pole units for the three phases of an alternating current to be switched, of which only one pole unit designated by 2 is shown in the figure. The pole unit 2 comprises a pole head 3 and a pole base 4, between which a contact system 5 in the form of a vacuum switching tube 5 for switching a current is arranged between a first conductor rail 6 and a second conductor rail 7 of the pole unit 2. A moving contact 8 of the vacuum switching tube 5 is coupled to a drive unit 10 of the power switch by means of a drive rod 9, the drive unit 10 being designed to introduce a switching movement into the moving contact 8 of the contact system 5. The moving contact 8 is connected to the second conductor rail 7 by means of second connecting elements 11. A fixed contact 12 of the vacuum switching tube 5 is electrically conductively connected to the first conductor rail 6 via first connecting elements 13. The pole unit is fastened to a retaining wall 16 of the power switch 1 by means of supporting devices 14 and 15.

FIG. 2 shows a cross-sectional view of a detailed representation in the area of the fixed contact 12 of the vacuum switching tube 5. The fixed contact 12 of the vacuum switching tube 5 in the form of a cylindrical bolt is circumferentially electron beam welded in the area 17 to the first connecting element 13 in the form of a copper plate, which has a recess corresponding to the bolt of the fixed contact 12, as a result of which a force-activated and fused connection is formed between the fixed contact 12 and the second connecting element 13. Furthermore, the second connecting element 13 is likewise electron beam welded to the first conductor rails 6 in the area 18. For the purpose of stabilization, an aluminum spacer 19 is arranged between the conductor rails.

FIG. 3 shows a detailed view in the area of the moving contact of the vacuum switching tube 5 from FIG. 1. At its narrow end 20 in the area 21, the moving contact 8 is circumferentially electron beam welded to the second connecting element 11 in the form of a copper plate with a recess corresponding to the bolt 20 of the moving contact 8. Flexible current conductors 22 and 23 are likewise electron beam welded to the second connecting element 11 in the areas 24 and to the second conductor rail 7 at 26 and 27. As a result of the force-activated and fused connection in the areas 21, 24, 25, 26 and 27, no further screw fittings are required as fastening elements in the area of the flexible current conductors 22 and 23 and the moving contact 8.

As can be seen from FIG. 1, the pole head 3 and the pole base 4 are provided with cooling bodies 3a and 4a respectively, which serve to dissipate the heat produced by the high currents in the area of the fixed contact 12 and the moving contact 8 respectively. Fastening elements 28 are provided on the first conductor rail 6 and fastening elements 29 are provided on the second conductor rail 7 for the purpose of connecting the high-current switch 1, the fastening elements being provided for bolting the first conductor rail 6 and the second conductor rail 7 respectively to busbars of a switchgear system for example. The temperature of the current-carrying parts is reduced by the cooling bodies 3a and 4a in such a way that the temperature in the area of the screw fittings 28 and 29 respectively lies in the required range of less than 65 to 75 degrees Kelvin above the ambient temperature.

### LIST OF REFERENCES

1 Power switch

2 Pole unit

3 Pole head

4 Pole base

5 Vacuum switching tube

6 First conductor rail

7 Second conductor rail

8 Moving contact

9 Drive rod

10 Drive unit

11 Second connecting element

12 Fixed contact

13 First connecting element

14, 15 Supporting devices

16, Retaining wall

17, 18 Connecting areas

19 Stabilizing element

20 Moving contact bolt

21 Connecting areas

22, 23 Flexible current conductor

24, 25, 26, 27 Connecting areas

28, 29 Fastening elements

3a, 4a Cooling bodies

1-3. (canceled)

4. A power switch, comprising:
at least one pole unit with a pole head and a pole base, said pole unit having a first conductor rail and a second conductor rail;
a vacuum switching tube connected between said pole head and said pole base, said vacuum switching tube having a fixed contact and a moving contact;
a first connecting element connecting said fixed contact to said first conductor rail of said pole unit and a second connecting element connecting said moving contact to said second conductor rail of said pole unit;
wherein said first connecting element is welded to said first conductor rail and to said fixed contact, and said second connecting element is welded to said second conductor rail and said moving contact.

5. The power switch according to claim 4, wherein said second conductor rail has a flexible current conductor and said second conductor rail is welded to said flexible current conductor and said second connecting element.

6. The power switch according to claim 4, wherein said connecting elements are electron beam welded.

7. The power switch according to claim 4 configured as a high-current switch.
